(19) United States
(12) Patent Application Publication
(10) Pub. No.: US 2025/0104088 A1
(43) Pub. Date: Mar. 27, 2025

(54) SYSTEM AND METHOD FOR PROVIDING ORDER SUPPORT ASSISTANCE

(71) Applicant: SHOPEE IP SINGAPORE PRIVATE LIMITED, Singapore (SG)

(72) Inventors: Lennard Guo Jie Foo, Singapore (SG); Hengjie Xiong, Singapore (SG); Fang Yang, Singapore (SG); Angie Hong Pei Phua, Singapore (SG); Cheuk Yan Ho, Singapore (SG)

(21) Appl. No.: 18/893,857

(22) Filed: Sep. 23, 2024

(30) Foreign Application Priority Data
Sep. 25, 2023 (SG) 10202302709T

(51) Int. Cl. G06Q 30/015

(52) U.S. Cl. CPC G06Q 30/015

(57) ABSTRACT

A system and method are disclosed for implementing a customer support interface for order support assistance. The method includes receiving a request for assistance corresponding to a customer account, the customer account being associated with orders, the customer account comprising customer account information and the orders comprising order attributes. The method further includes predicting whether the request for assistance relates to orders, wherein the predicting is based on one of, or both of, the customer account information and the order attributes of the orders. In response to predicting that the request for assistance relates to the orders, the method determines an intended order from the orders, wherein the intended order represents the order with the highest probability of having initiated the request for assistance, and causes the intended order to be displayed on the customer support interface on a customer device.

### CROSS-REFERENCE TO RELATED APPLICATIONS

This patent application claims the benefit and priority of Singaporean patent application Ser. No. 10202302709T, filed with the Intellectual Property Office of Singapore on Sep. 25, 2023 entitled “SYSTEM AND METHOD FOR PROVIDING ORDER SUPPORT ASSISTANCE”, the content of which is incorporated by reference in its entirety.

### FIELD OF THE INVENTION

The present invention generally relates to providing order support assistance to the customer. In particular, the present invention pertains to a system and method for implementing an online customer support interface.

### BACKGROUND

Chatbots have been touted to provide a multitude of benefits for companies and customers and have become an indispensable element in modern customer service experience. Many businesses (e.g. e-commerce platforms) implement chatbots to help automate routine tasks and repetitive tasks, such as responding to general questions, and offering self-service options to the customers to help them find the answers without intervention by a customer service agent. By deflecting simple tasks and customer queries, customer service agents can then focus on handling complex issues or requests that require a human touch.

However, chatbots suffer from a number of limitations, the primary limitation being that it is an automated system governed by rules. Therefore, in the minds of most customers, resolution of the customers' queries can be lengthy and time-consuming because the chatbot may not provide the desired assistance straightaway. This may lead to customers completely circumventing the chatbots and directly seeking assistance from customer service agents, thereby straining an already limited resource.

Consequently, and considering that customers are usually asking about orders on e-commerce platforms, there is a need for chatbots to automatically provide proactive support (even before the customer provides any specific input) by predicting and displaying orders in which the customers are most likely seeking assistance for, or at least provide a novel chatbot.

### SUMMARY OF INVENTION

According to a first aspect of the present invention, a method for implementing a customer support interface for order support assistance is disclosed. The method includes receiving a request for assistance corresponding to a customer account of a customer, the customer account being associated with at least one order, wherein the customer account comprises customer account information, and wherein the at least one order comprises order attributes. The method further comprises predicting with a prediction engine implementing a machine learning model, whether the request for assistance relates to the at least one order, wherein the predicting is based on one of, or both of, the customer account information and the order attributes of the at least one order.

In response to predicting that the request for assistance relates to the at least one order, the method determines with the prediction engine, an intended order from the at least one order, wherein the intended order represents the at least one order with the highest probability of having initiated the request for assistance, and causes the intended order to be displayed on the customer support interface on a customer device.

According to some aspects of the subject technology, the step of determining the intended order from the at least one order comprises the steps of calculating a score for each of the at least one order based on the order attributes of the at least one order, the score of the at least one order representing the probability of the at least one order having initiated the request for assistance; and identifying the at least one order with the highest score to be the intended order.

According to some aspects of the subject technology, the method further includes retrieving order attributes of the intended order, determining by the prediction engine, one or more prompts based on the order attributes of the intended order, and causing the one or more prompts to be displayed with the intended order on the customer support interface.

According to some aspects of the subject technology, the step of determining the one or more prompts comprises retrieving a set of prompts from a database, and selecting one or more prompts from the set of prompts according to a predefined rule.

According to some aspects of the subject technology, the one or more prompts is to be displayed with the intended order in a chatbot session on the customer support interface.

According to some aspects of the subject technology, the method further includes ranking the at least one order based on the score of the at least one order, and determining with the prediction engine, at least one other order from the at least one order, wherein the at least one other order has an inferior score compared to the intended order.

According to some aspects of the subject technology, the method further includes causing the intended order to be displayed more prominently on the customer support interface compared with the at least one other order.

According to some aspects of the subject technology, causing the intended order to be displayed more prominently on the customer support interface compared with the at least one other order comprises the steps of causing the intended order to be displayed on a first interface of the customer support interface, and causing a selectable link to be presented on the first interface, wherein the at least one other order is displayed on a second interface of the customer support interface in response to a customer selection of the selectable link.

According to some aspects of the subject technology, the at least one other order is displayed on the second interface based on the ranking of the at least one order.

According to some aspects of the subject technology, the method further includes receiving an input from the customer which affirms that the request for assistance was related to the intended order; and updating the machine learning model of the prediction engine.

According to some aspects of the subject technology, the input from the customer which affirms that the request for assistance was related to the intended order, comprises any one of: a query entered by the customer in the chatbot session about the intended order, a customer selection of a selectable element representing the intended order, or a customer selection of a selectable element representing the one or more prompts.

According to some aspects of the subject technology, the method further includes receiving an input from the customer which affirms that the request for assistance was not related to the intended order; and updating the machine learning model of the prediction engine.

According to some aspects of the subject technology, the input from the customer which affirms that the request for assistance was not related to the intended order, comprises any one of: a query entered by the customer in the chatbot session relating to an order which is not the intended order, a query entered by the customer in the chatbot session that is not related to the intended order, a customer selection of a selectable element that is not related to the intended order, or the customer terminating the chatbot session.

According to some aspects of the subject technology, the method further includes receiving an input from the customer that indicates relevance of the one or more prompts; and updating the machine learning model of the prediction engine.

According to some aspects of the subject technology, the input from the customer that indicates relevance of the one or more prompts, comprises a query entered by the customer in the chatbot session that is related to the one or more prompts, or a customer selection of a selectable element that represents the one or more prompts.

According to some aspects of the subject technology, the method further includes receiving an input from the customer that indicates non-relevance of the one or more prompts; and updating the machine learning model of the prediction engine.

According to some aspects of the subject technology, the input from the customer that indicates non-relevance of the one or more prompts, comprises any one of: a query entered in the chatbot session that is not related to any of the one or more prompts, a customer selection of a selectable element that is not any of the one or more prompts, and the customer terminating the chatbot session.

According to some aspects of the subject technology, the customer account information comprises any one of or any combination of the following: customer profile information, customer activity information, and historical chat information.

According to some aspects of the subject technology, the order attributes comprises any one of or any combination of the following: order status, order date, planned delivery date, actual order delivery date, delivery method, order value, order history, payment method, order payment status, merchant identifier, and item identifier.

According to some aspects of the subject technology, the request for assistance is initiated via the activation of a help button on a home page of an e-commerce platform, and wherein the home page of the e-commerce platform provides no information on the at least one order.

According to some aspects, the present invention provides a system comprising one or more computers and one or more storage devices storing computer-readable instructions that, when executed by the one or more computers, cause the one or more computers to perform the steps of any of the above-described methods. The same applies to one or more non-transitory computer storage media storing instructions that, when executed by one or more computers, cause the one or more computers to perform the steps of any of the above-described methods. The method can thus be easily transferred to other systems and carried out there.

### BRIEF DESCRIPTION OF DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 shows a schematic diagram of a system for implementing a customer support interface according to certain embodiments.

FIG. 2 shows a table containing exemplary orders and their exemplary order attributes according to certain embodiments.

FIG. 3 shows a table indicating the ranking of the exemplary orders based on their scores according to certain embodiments.

FIG. 4 shows a flowchart illustrating a method for implementing a customer support interface according to certain embodiments.

FIG. 5 shows a flowchart illustrating a method for implementing a customer support interface according to certain embodiments.

FIG. 6 shows a flowchart illustrating a method for implementing a customer support interface according to certain embodiments.

FIGS. 7A-7C show an exemplary customer support interface according to certain embodiments.

FIGS. 8A-8C show an exemplary customer support interface according to certain embodiments.

Skilled artisans will appreciate that elements in the figures are illustrated for simplicity and clarity and have not necessarily been depicted to scale. For example, the dimensions of some of the elements in the block diagrams or steps in the flowcharts may be exaggerated relative to other elements to help improve understanding of the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

It is the intent of certain embodiments to teach a system and method for implementing a customer support interface. The customer support interface can be provided by a commercial entity (e.g. an e-commerce platform, etc.) as a means of providing order support assistance to its online customers including, but not limited to, predicting orders in which the customers are most likely seeking assistance on, and causing these orders to be displayed, even before receiving any specific input from the customers.

In some embodiments, the method can comprise the step of receiving a request for assistance corresponding to a customer account of a customer. The customer account can be associated with orders placed with the e-commerce platform and the orders can comprise order attributes. The customer account can comprise customer account information.

In some embodiments, the method can comprise the step of predicting whether the request for assistance relates to orders (i.e. whether the request for assistance is order-related). The orders can be for example, orders which had been previously placed by the customer on the e-commerce platform. The prediction can be performed by a prediction engine. The prediction engine can implement a machine learning model. The prediction can be based on the customer account information and the order attributes of the orders. The customer account information can non-exhaustively include customer profile information, customer activity information, and historical chat information, or the like. The order attributes can comprise order number, order status, order date, planned delivery date, actual order delivery date, delivery method, order value, order history, payment method, order payment status, merchant identifier, item identifier, or the like.

When the prediction is that the request for assistance is not related to any orders, the method can cause non order-related questions to be displayed on the customer support interface on the customer device.

When the prediction is that the request for assistance is related to orders, the method can comprise the step of determining an intended order (from among the orders), wherein the intended order can represent the order with the highest probability of having initiated the request for assistance. The determination can comprise calculating a score for each of the orders based on order attributes of the orders, and the order which has the highest score can be identified as the intended order. In other words, the method determines the specific order which the customer is most likely to be seeking assistance on.

The request for assistance can be initiated via the activation of a help button on a home page of the e-commerce platform. The home page of the e-commerce platform does not need to provide any information on the orders.

The abovementioned method is advantageous because it proactively and automatically predicts the intended order which the customer is most likely seeking assistance or needing help on. The intended order is displayed in the chatbot session on the customer support interface, even before the customer has provided any input, or asked any questions or raised any concerns. This proactive prediction of the intended order will result in “immediate engagement” with the customer, effectively shortening the time and the number of interactions that would otherwise be required for the chatbot to troubleshoot or identify underlying orders.

Typically, customers would be required to first provide details about the order that they are having issue with before the chatbot can propose any order-specific solutions or answers, therefore creating a lengthy and undesirable experience for the customers. On the other hand, the present invention requires no prior input from the customer, and automatically predicts the intended order which the customer is most likely enquiring about. As customers become more and more engaged in a chatbot session as the chatbot is providing relevant assistance, the likelihood of transferring to a customer service agent can be minimised, thereby improving and optimising operational efficiency and mitigating operational costs.

The method also selectively executes a determination of the intended order only when it is has been predicted that the request for assistance is order-related (i.e. relates to the previously made orders by the customer). Conversely, when it is has been predicted that the request for assistance is not order-related, the method does not execute a determination of the intended order. This is advantageous because executing a prediction for the intended order whenever a customer initiates a request for assistance can lead to unnecessary resource utilization, as the customer may simply be inquiring about an issue which is not related to any of his/her orders. By determining the intended order only when it has been predicted that the request for assistance is likely to be order-related, the present invention advantageously conserves on computational resources (e.g. CPU processing time, memory usage, etc.) and provides efficient management of computational resources, while delivering on its objectives on providing a more proactive chatbot.

In some embodiments, the method can comprise the steps of determining prompts based on order attributes of the intended order and causing the prompts to be displayed with the intended order on the customer support interface. The prompts can be displayed with the intended order in the chatbot session on the customer support interface. The prompts can be displayed in the form of a selectable element on the customer support interface to be selected if the customer so desires. The selectable element can be a prompts card. Prompts can refer to, for example, suggested questions or suggested content relevant to the intended order. In other words, prompts refer to the likely queries or requests that the customer may have in relation to the intended order.

Displaying the prompts (e.g. suggested questions or content) for selection by the customer, even before the customer provides any specific input on the customer support interface, is advantageous as it facilitates communication about the intended order while creating a personalized chat experience for the customer. For example, one or more prompts can be automatically suggested based on the intended order, and the customer can conveniently select from the prompts to advance the chatbot conversation. Such prompts allow a customer to simply and quickly query about the intended order, thereby improving the resolution rate for order-related issues by the chatbot while simultaneously shortening the time that would otherwise be required for the customer to resolve issues via the chatbot. For example, the customer can select the desired prompt to access relevant resolutions to the order-related issues. The prompts can also be particularly useful for customers who are unable to properly articulate their issues regarding their orders. Furthermore, proactively providing customers with suggested questions to possible order-related issues may also resolve issues before they occur, thereby increasing the customer's satisfaction in using the chatbot.

In some embodiments, the method can comprise the steps of ranking orders based on their scores and then determining other orders that have an inferior score compared to the intended order. The “other orders” can represent orders that have been deemed to have a lower probability/likelihood of having initiated the request for assistance compared to the intended order.

In some embodiments, the method can cause the intended order to be displayed more prominently on the customer support interface compared with the other orders. For example, the intended order can be displayed on a first interface of the customer support interface with a selectable link, and the other orders can be displayed on a second interface of the customer support interface in response to a customer selection of the selectable link. The selectable link can be a hyperlink, a browser tab, a selectable button, a scrollable element, or any selectable element, or the like.

As the intended order represents the order with the highest probability/likelihood of having initiated the request for assistance by the customer, making the intended order easily distinguishable from the other orders makes the interface more user-friendly. Thus, convenient and proactive order support is provided as the customer can conveniently select the order card representing the intended order and immediately proceed with the chat query.

Furthermore, due to the widespread use of mobile devices for purchasing items online via e-commerce platforms, optimizing screen layouts can drastically improve customer engagement. As the screens of customer devices are typically limited in size, it is therefore advantageous to first display the intended order by itself (without unnecessary elements cluttering the screen display), and only fully display the other orders on a second interface or window upon selection by the customer. This provides a well-structured screen layout that is both practical and visually appealing to the customer.

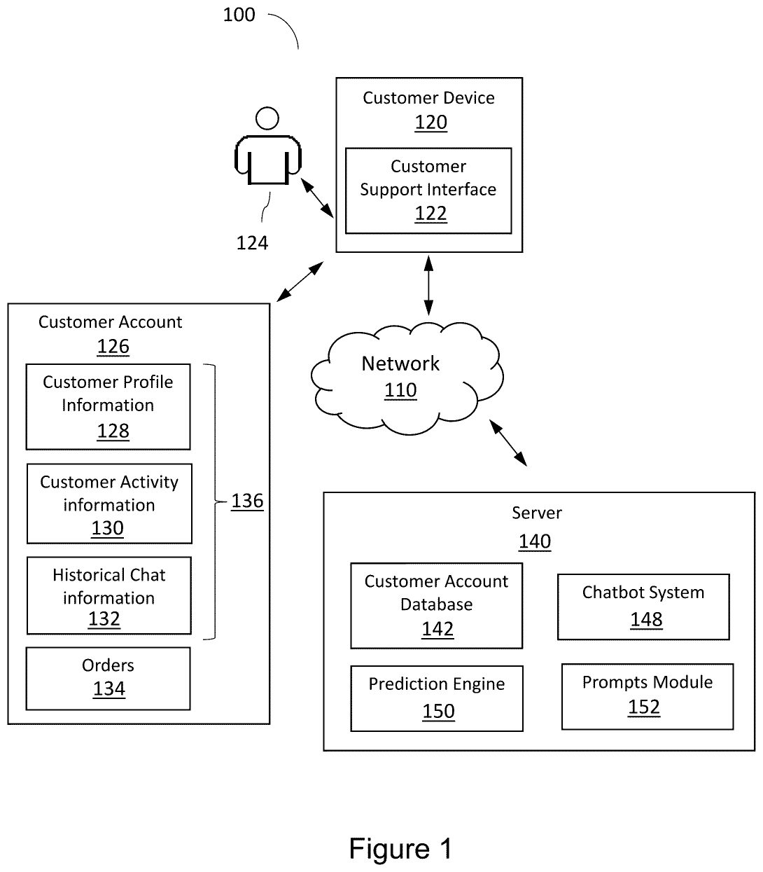

FIG. 1 shows a schematic diagram of a system 100 for implementing a customer support interface according to certain embodiments. The system 100 may include one or more components, modules or layers, which may be implemented using software and/or hardware, optionally across multiple locations or using multiple devices or units. An overview of the system 100 is described in relation to FIG. 1. Thereafter, a more detailed description of the system 100 is provided in relation to remaining figures.

The system 100 may be implemented as a single system, multiple systems, distributed systems, or in any other form. Each component of the system 100 may be any type of computing device that is suitable for performing the functionality required by one or more embodiments of the present invention, and capable of communicating with each other directly or over a network 110. In some embodiments, the system 100 includes a customer device 120, and a server 140 communicatively coupled to each other via the network 110.

The network 110 illustrated in FIG. 1 may include any number of suitable networks and/or network types. For example, the network 110 may include, but is not limited to, one or more of virtual private networks (VPNs), local area networks (LANs), wide area networks (WANs) such as the Internet, wireless WANS (WWANS), metropolitan area networks (MANs), Wi-Fi networks, WiMAX® networks, Bluetooth® communication networks, peer-to-peer networks, cellular telephone networks, or any combination of such networks. The network 110 can include any combination of connections (e.g., wired, wireless, or fiber optic connections) and protocols that will support communications between each component in the system 100 in accordance with one or more embodiments of the invention. For example, data transmitted by the network 110 may include packetized data, e.g., Internet Protocol (IP) data packets, that is routed to designated computing devices coupled to the network 110. The network 110 may include networking software and/or hardware that interconnects the computing devices of the system 100. For example, the network 110 may include packet-switching devices that route the data packets to the various computing devices based on information included in a header of the data packets.

The data exchanged over the network 110 can be represented using technologies and/or formats including the hypertext markup language (HTML), the extensible markup language (XML), JavaScript Object Notation (JSON), Comma Separated Values (CSV), Java DataBase Connectivity (JDBC), Open DataBase Connectivity (ODBC), etc. In addition, the data exchanged over the network can be encrypted using encryption technologies, for example, the secure sockets layer (SSL), Secure HTTP (HTTPS) and/or virtual private networks (VPNs) or Internet Protocol security (IPsec).

It should be appreciated that custom and/or dedicated data communications technologies instead of, or in addition to, the ones described above can also be used to perform the functionality required by one or more embodiments of the present invention.

The server 140 illustrated in FIG. 1 may take the form of one or more web-based server computers, such as a web server, an application server, a database server, etc., that are capable of communicating with the customer device 120 over the network 110. For example, the server 140 may be embodied in a single server computer, or distributed as a plurality of interconnected server computers, and operate in a cloud computing environment. The server 140 can include a processor and a memory. A memory may be volatile or non-volatile types of non-transitory computer-readable media, such as magnetic media, optical media, random access memory (RAM), read-only memory (ROM), removable media, or any other suitable local or remote memory unit. The memory can include digital data that can be accessed by the processor. A processor may be any type of device, or multiple devices, capable of manipulating or processing information from a non-transitory computer-readable media (e.g., a memory). For example, a processor includes a central processing unit (CPU) for processing computer-executable program instructions to perform one or more processes.

The server 140 can include one or more storage devices storing data structures and/or computer instructions for execution by the processor. For example, the server 140 can include one or more computer-readable data stores to support the functionality required by one or more embodiments of the invention. Various types of computing devices may be employed for the server 140. For example, the computer may be a mainframe, a workstation, as well as other types of processing devices. The memory may include digital data that can be accessed by the processor. The server 140 and/or data store may be coupled with various databases or storage devices in the form of any suitable computer readable medium, such as a hard disc drive, a memory device, a flash drive or an optical drive.

In some embodiments, an e-commerce platform (not shown) may be implemented wholly or partially on the server 140. The e-commerce platform may provide merchants with online resources and facilities for managing their business. Merchants may utilize the e-commerce platform for managing commerce with customers, such as by implementing an e-commerce experience with customers through an online store. An online store may refer to the multitenant collection of storefronts supported by the e-commerce platform (e.g., for a plurality of merchants) or to an individual merchant's storefront (e.g., a merchant's online store). For example, the server 140 can support a single integrated website (also referred to as a multi-merchant website), which functions as a virtual shopping mall. In some embodiments, the e-commerce platform provides customers with online customer support, such as by implementing a chatbot system 148 and a live chat system (not shown) to communicate with customer service agent. In some embodiments, the online stores are served by the e-commerce platform to customers 124 who have registered an account with the e-commerce platform as will be described in more detail below.

The customer device 120 as illustrated in FIG. 1 is representative of any number of customer devices that can be included in the system 100. Each customer device 120 is a computing device having data processing and communication capabilities. In some embodiments, a customer device 120 may include a processor (e.g., CPU), a memory (e.g. RAM, ROM, etc.), a power source, a network interface, and/or other software and/or hardware components, such as a display, graphics processor, wireless transceivers, keyboard, speakers, camera, sensors, firmware, operating systems, drivers, various physical connection interfaces (e.g., USB, HDMI, etc.). For example, the customer device 120 may take the form of one or more personal computers, tablet computers, smart phones, mobile phones, wearable devices, home entertainment computers, network computing devices, mobile computing device, personal digital assistants, virtual machines, servers, other computing devices, or any combination of such computing devices.

The customer support interface 122 represents the graphical user interface (GUI) to be displayed via a display screen on the customer device 120.

Customer account 126 may be associated with a customer 124 of the e-commerce platform. For example, the customer 124 may have one or more customer accounts 126 registered with the e-commerce platform. The customer account 126 can have a unique identifier (e.g. a unique string of numbers). The customer account 126 can include customer account information 136. The customer account 126 as illustrated in FIG. 1 is representative of any number of customer accounts that can be included in the system 100. Customer accounts 126 can be stored in customer account database 142.

A customer 124 can interact (or interface) with the server 140 using the customer device 120. The customer 124 as illustrated in FIG. 1 is representative of any number of customers that can be included in the system 100. The customer account information 136 can include customer profile information 128. Customer profile information 128 can non-exhaustively include name, address, age, gender, race, nationality, occupation, email contact, contact numbers, geographic location, information relating to one or more forms of payment (e-wallets, debit/credit cards, or bank accounts) and any other information corresponding to customer 124.

The customer account information 136 can include customer activity information 130. The customer activity information 130 can include the recent and historical activity of the customer 124, and includes, but not limited to, historical page views, page views representing product interests, or any other page views, payment activity data (e.g. data relating to one or more forms of payment activity) and any other activity information corresponding to a customer 124. For example, the customer activity information 130 of each customer 124 may be acquired from clickstream data, including any actions taken by the customer 124 such as adding an item to a shopping cart or any suitable action taken by the customer's 124 navigational activity in the e-commerce platform or otherwise.

The customer account information 136 of the customer 124 can include historical chat information 132 of the customer 124, e.g. chat session information related to a current chat session or previous chat sessions with the customer 124. The historical chat information 132 can include previous chat transcripts of the conversations between each customer 124 and the chatbot and/or human agent from the chat sessions conducted on the customer support interface 122.

The historical chat information 132 can also include historical resolution data from previous chat interactions with the customer 124. The resolution data can include actions identified to resolve an order-related issue, or actions taken to resolve an order-related issue. For example, the actions identified to resolve an order-related issue can include any proactive (i.e. before receiving any specific input from the customer 124) or reactive (i.e. after receiving specific input from the customer 124) actions identified in an attempt to resolve the order-related issue.

The customer account 126 can also include orders 134 associated with the customer 124. The orders 134 can be orders that have been placed by the customer 124. The orders 134 can include any order 134 where payment has been completed, or orders 134 where the items in the shopping cart have been “checked out” but pending payment. Each order 134 can have a unique order number.

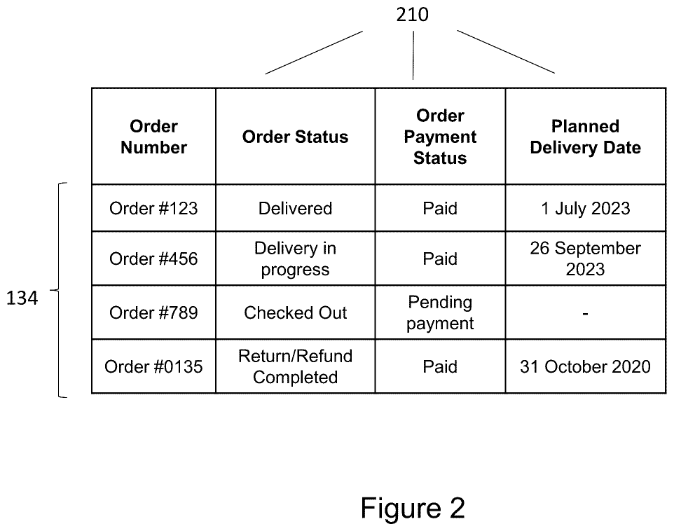

The orders 134 can comprise order attributes 210 (as shown in FIG. 2). The order attribute 210 can be any parameter or attribute that can convey useful information about order 134. The order attribute 210 and its values can be used to compare and contrast among the orders 134. As will be described in detail later, the information as provided by the order attributes 210 and its values can be used to help predict whether the request for assistance is order-related, and also help determine the order 134 that the customer 124 is likely seeking assistance for.

The order attributes 210 of the order 134 may non-exhaustively include order number, order status, order date, planned delivery date, actual order delivery date, delivery method, order value, order history, payment method, order payment status, merchant identifier, item identifier, and the like. Exemplary order attributes 210 and their exemplary values are shown in FIG. 2. The values of the order attributes 210 can change through time. For example, the value of order attribute 210 “order status” can change from “checked out”, “delivery in progress” and then to “delivered”. In another example, the value of order attribute 210 “order payment status” can change from “pending payment” and then to “paid”.

The server 140 can include the customer account database 142, a chatbot system 148, a prediction engine 150, and a prompts module 152. The customer account database 142 can be a data store that stores customer accounts 126. The prompts module 152 can be a data store that stores sets of prompts.

The chatbot system 148 can provide a chatbot and a graphical user interface for customers 124 to communicate with the chatbot. The chatbot system 148 can receive and transmit inputs to and from the customer 124 via the customer device 120 to be displayed on the graphical user interface. For example, the chatbot system 148 can receive a request for assistance by a customer 124 transmitted from the customer device 120 to be displayed on the graphical user interface. The graphical user interface is, for example, the customer support interface 122 as described herein, or more particularly, the chatbot session on the customer support interface 122. The chatbot system 148 can determine whether the request for assistance is a new conversation request or part of an existing conversation session. The chatbot system 148 can determine if the conversation session is completed based on a completion signal (e.g. interface window closed) from the customer device 120. The chatbot system 148 can be configured to receive input data from the prediction engine 150.

The prediction engine 150 can include a program or algorithm such as a machine learning model (e.g. neural network) that performs functions in accordance with the described embodiments. The prediction engine 150 as illustrated in FIG. 1, is representative of any number of prediction engines that can be included in the system 100. In some embodiments, in response to receiving the request for assistance from the customer 124, the prediction engine 150 is configured to acquire the customer account information 136 and the order attributes 210 of the orders 134 from the customer account 126 of customer 124 from customer account database 142.

As mentioned before, the customer account information 136 can include the customer profile information 128, the customer activity information 130, and the historical chat information 132. With the customer account information 136 and the order attributes 210 of the orders 134, the prediction engine 150 can predict whether the request for assistance by the customer 124 is order-related. For example, a request that is order-related can include any requests relating to order fulfilment issue (e.g. delivery delays), payment issues relating to specific orders, order returns or refunds, and the like. A request that is non-order related can include any requests relating to account verification (e.g. password retrieval, deactivated account), general payment queries (e.g. payment methods, discount codes, e-wallet queries), or product-related questions.

In some embodiments, the prediction engine 150 can predict whether the request for assistance by the customer 124 is order-related by analysing the customer account information 136 and the order attributes 210 of the orders 134. This analysis can be done holistically by considering the customer account information 136 together with the order attributes 210 of the orders 134, or in turn.

The customer account information 136 can be useful information in determining whether the request for assistance is order-related. For example, if the customer activity information 130 of the customer account information 136 indicates that the customer 124 had recently viewed the order history repeatedly, then the prediction engine 150 is likely to predict/determine that the request for assistance is order-related. In yet another example, if the historical chat information 132 of the customer account information 136 indicates that the customer 124 had participated in recent chatbot conversations regarding orders 134, then the prediction engine 150 is likely to predict/determine that the request for assistance is order-related. It should be appreciated that the prediction engine 150 can additionally identify any suitable number of issues associated with the customer account 126 to predict whether the request for assistance is order-related or not.

Conversely, the customer account information 136 can also be useful information in determining whether the request for assistance is not order-related. For example, if the customer profile information 128 of the customer account information 136 indicates that the customer 124 has a frozen e-wallet account, then the prediction engine 150 is likely to predict/determine that the request for assistance is not order-related (as the customer 124 would most likely be enquiring on how to “unfreeze” the account as opposed to be asking about orders 134).

The order attributes 210 of the orders 134 can be useful information in determining whether the request for assistance is order-related. For example, if the value of the order attribute 210 “order status” of any order 134 indicates that the order 134 is still being delivered, and yet the value of the order attribute 210 “planned delivery date” has passed, then the prediction engine 150 is likely to predict/determine that the request for assistance is order-related. In another example, if the value of the order attribute 210 “order status” of any order 134 indicates that the order 134 has been checked-out, and yet the value of the order attribute 210 “order payment status” indicates that the order 134 has not yet been paid i.e. “pending payment”, then the prediction engine 150 is likely to predict/determine that the request for assistance is order-related.

In yet another example, if the value of order attribute 210 “order status” of any order 134 indicates that the order 134 has been completed, and the value of the order attribute 210 “order payment status” indicates that the order 134 has been paid, then the prediction engine 150 is likely to predict/determine that the request for assistance is not order-related. In yet another example, if the value of order attribute 210 “order status” of any order 134 indicates that return or refund for the order 134 has been finalized, and that the return or refund for the order 134 has been processed i.e. “return/refund completed”, then the prediction engine 150 is likely to predict/determine that the request for assistance is not order-related as there is no outstanding issue with the order 134.

Therefore, in determining whether the request for assistance is order-related, the analysis of the order attributes 210 of the orders 134 can be performed on a macro-level i.e. the values of the order attributes 210 of the orders 134 are considered together, instead of comparing the values of the order attributes 210 or among the orders 134 themselves.

In some embodiments, the prediction engine 150 can analyse the order attributes 210 of the orders 134 with reference to a predetermined threshold. For example, the predetermined threshold for order attribute 210 “planned delivery date” can be “two days out”. Therefore, if there are any orders 134 with a value for order attribute 210 “planned delivery date” which is two days from the current date, then the prediction engine 150 is likely to determine that the request for assistance is order-related.

In some embodiments, each order attribute 210 can have a predetermined threshold, and the prediction engine 150 can make the determination that the request for assistance is order-related if a certain number of predetermined thresholds are exceeded.

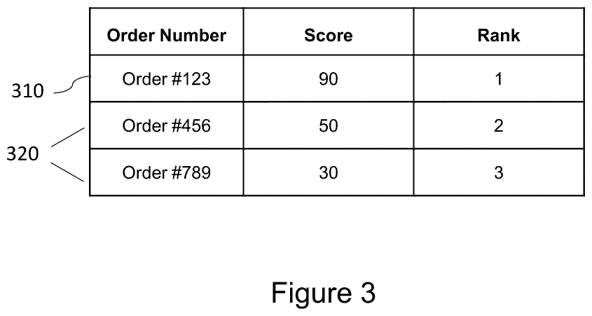

In some embodiments, responsive to the prediction that the request for assistance by the customer 124 is order-related, the prediction engine 150 can be configured to automatically determine an intended order 310 (as shown in FIG. 3). The intended order 310 can represent the order 134 with the highest probability of having initiated the request for assistance by the customer 124. The determination of the intended order 310 can be based on the order attributes 210 of the orders 134. The determination can involve calculating a score for each order 134 based on the order attributes 210. The score can represent the probability of the order 134 as having initiated the request for assistance. The order 134 with the highest score can be identified to be the intended order 310 (as shown in FIG. 3).

In some embodiments, the score of the order 134 can be calculated by assigning weights to each of the order attributes 210, as some order attributes 210 can be more important than others. For example, order attribute 210 “order status” may be assigned the highest weight. The score of each order 134 can be a summation of the “normalized” values of the order attributes 210 multiplied by their respective weights.

As shown in FIG. 3, the orders 134 can be ranked based on their scores. The order 134 which is the top ranked can be the intended order 310. The orders 134 which have inferior scores compared to the intended order 310 (i.e. lower ranked) can be the other orders 320. As described, the determination of the intended order 310 and the other orders 320 can be done by comparing the scores and in essence the values of the order attributes 210 between the orders 134 or among themselves (i.e. at the order level and not at the macro level).

The prediction engine 150 can be configured to receive feedback information as input data to update one or more portions of the machine learning model. The feedback information can be “positive” and include customer indications of the accuracy of the prediction (e.g. a customer input confirming the accuracy of the prediction). The feedback information can also be “negative” and include customer indications refuting the accuracy of the prediction. Based on the feedback information, the machine learning/neural network model can be trained and data may be updated. In this way, prediction engine 150 is constantly being trained and refined to generate more accurate predictions.

The prediction engine 150 can query the prompts module 152 to retrieve a set of prompts. The prediction engine 150 can select one or more prompts from the set of prompts based on the order attributes 210 of the intended order 310. These prompts can be selected via a predefined rule. The predefined rule generally comprises one or more conditions and one or more actions to be taken if the conditions are satisfied. It should be understood that the pre-defined rule may include multiple conditions with potentially complicated inter-relationships among the conditions.

For example, if the value of order attribute 210 “order status” of the intended order 310 is “delivery in progress”, the predefined rule can then dictate that prompts that are associated with “delivery in progress” are to be selected. For example, the prompts that are associated with “delivery in progress” can be:
(1) Prompt 1—When will I receive my order?
(2) Prompt 2—How can I request to track or expedite my order delivery?
(3) Prompt 3—Can I change my delivery address after my order has been placed?
   In another example, if the value of order attribute 210 “order payment status” of the intended order 310 is “pending payment”, the predefined rule can then dictate that prompts that are associated with “pending payment” are to be selected. For example, the prompts that are associated with “pending payment” can be:
(4) Prompt 4—Why can't I check out with my credit card?
(5) Prompt 5—Why is the discount voucher not applied?
(6) Prompt 6—Can I get a payment confirmation email for my order?
   Thus, the predefined rules can result in the selection of prompts by the prediction engine 150 which are deemed to be most relevant to the intended order 310.

In an alternative implementation, the prompts may be selected by the prediction engine 150 based on how relevant they are to a value of the order attribute 210 of the intended order 310. For example, the prompts may be selected based on the probability of matching the prompts to a value of the order attribute 210 of the intended order 310. The prompts with higher probabilities (e.g. higher confidence scores of matching to an order attribute 210) may be selected. For example, Prompts 1, 2 or 3 may be selected based on how relevant they are when the value of the order attribute 210 “order status” of the intended order 310 is “delivery in progress”.

It should be understood that the system 100 illustrated in FIG. 1 is representative of an exemplary system according to one or more embodiments and that a variety of different system environments and configurations are contemplated and are within the scope of the present disclosure. Furthermore, the system 100 may include automatic speech recognition (ASR) functionality (not shown), which may enable verbal/voice input (e.g., via VOIP) by customer 124 and/or requests, and text-to-speech (TTS) functionality into customer support interface 122, which may enable, verbal output by the system 100 to an end-user (or user) of the system 100 to customer device 120. However, it should be recognized that customer 124 may enter text input into customer support interface 122 and the system 100 may provide outputs to customer support interface 122 via text.

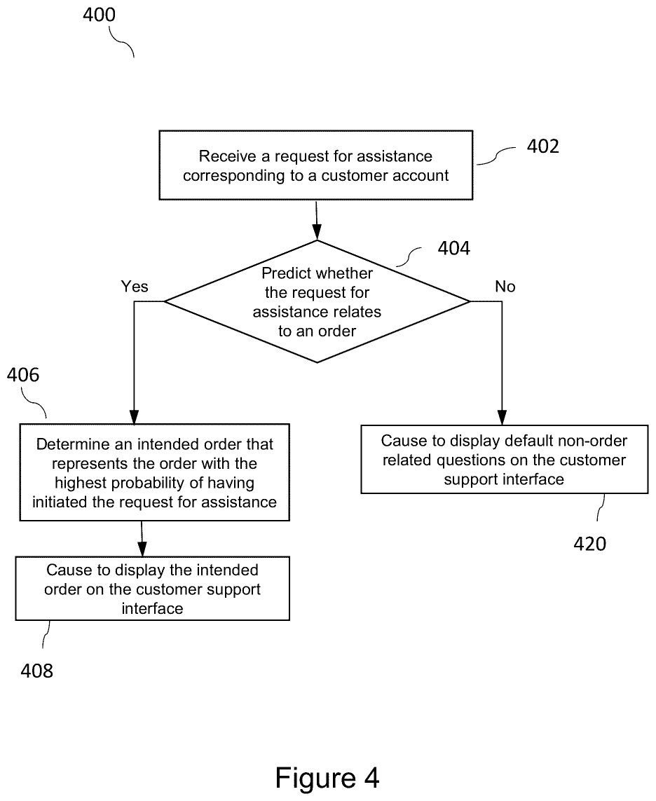

FIG. 4 shows a flowchart illustrating a method 400 for implementing a customer support interface 122 according to certain embodiments. The method 400 is explained in conjunction with the system 100 as described earlier through the previous figures of the disclosure and same or similar processes and elements may not be described in detail. The steps identified in FIG. 4 are exemplary and may include various alternatives, equivalents, or derivations thereof including but not limited to the order of execution of the same. The steps of FIG. 4 (and its various alternatives) may be embodied in hardware or software including a computer-readable storage medium including instructions executable by the likes of a processor in a computing device.

In step 402, the method 400 receives a request for assistance corresponding to a customer account 126. In some embodiments, it can be assumed that prior to this step, the customer 124 has already logged into his/her registered customer account 126 on the e-commerce platform using customer device 120. The customer account 126 can be associated with orders 134 which the customer 124 had placed on the e-commerce platform. The orders 134 can comprise order attributes 210. The customer account 126 can comprise customer account information 136.

The request for assistance may be initiated by the customer 124 via customer device 120 by for example, clicking on a chat interface element (e.g. “Help” button) on the home page or main page of the e-commerce platform. This home/main page of the e-commerce platform does not need to display any information on the orders 134.

In step 404, in response to the request for assistance, the method 400 predicts whether or not the request for assistance relates to the orders 134 (i.e. whether the request for assistance is order-related). For example, a request that is order-related can include any requests relating to order fulfilment issue (e.g. delivery delays), payment issues relating to specific orders, order returns or refunds. A request that is non-order related can include any requests relating to identity verification (e.g. password retrieval, deactivated account), general payment queries (e.g. payment methods, discount codes, e-wallet account queries), or product-related questions.

In some embodiments, the predicting step can be done by the prediction engine 150. In response to receiving the request for assistance, the prediction engine 150 can acquire the customer account information 136 and the order attributes 210 of the orders 134 from the customer account 126 of the customer 124 from the customer account database 142.

The customer account information 136 can include the customer profile information 128, the customer activity information 130, and the historical chat information 132. With the customer account information 136 and the order attributes 210 of the orders 134, the prediction engine 150 can predict whether the request for assistance by the customer 124 is order-related.

The prediction engine 150 can predict whether the request for assistance by the customer 124 is order-related by analysing the customer account information 136 and the order attributes 210 of the orders 134. This analysis can be done holistically by considering the customer account information 136 together with the order attributes 210 of the orders 134, or in turn.

The customer account information 136 can be useful information in determining whether the request for assistance is order-related. For example, if the customer activity information 130 of the customer account information 136 indicates that the customer 124 had recently viewed the order history repeatedly, then the prediction engine 150 is likely to predict/determine that the request for assistance is order-related. In yet another example, if the historical chat information 132 of the customer account information 136 indicates that the customer 124 had participated in recent chatbot conversations regarding the orders 134, then the prediction engine 150 is likely to predict/determine that the request for assistance is order-related.

Conversely, the customer account information 136 can also be useful information in determining whether the request for assistance is not order-related. For example, if the customer profile information 128 of the customer account information 136 indicates that the customer 124 has a frozen e-wallet account, then the prediction engine 150 is likely to predict/determine that the request for assistance is not order-related (as the customer 124 would most likely be enquiring on how to “unfreeze” the account as opposed to be asking about orders 134).

The order attributes 210 of the orders 134 can be useful information in determining whether the request for assistance is order-related. For example, if the value of the order attribute 210 “order status” of any order 134 indicates that the order 134 is still being delivered, and yet the value of order attribute 210 “planned delivery date” has passed, then the prediction engine 150 is likely to predict/determine that the request for assistance is order-related. In another example, if the value of order attribute 210 “order status” of any order 134 indicates that the order 134 has been checked-out, and yet the value of order attribute 210 “order payment status” of that order 134 indicates that the order 134 has not yet been paid i.e. “pending payment”, then the prediction engine 150 is likely to predict/determine that the request for assistance is order-related.

In yet another example, if the value of order attribute 210 “order status” of any order 134 indicates that order 134 has been completed, and the value of the order attribute 210 “order payment status” indicates that the order 134 has been paid, then the prediction engine 150 is likely to predict/determine that the request for assistance is not order-related. In yet another example, if the value of order attribute 210 “order status” of any order 134 indicates that the return or refund for the order 134 has been finalized, and that the return or refund for the order 134 has been processed i.e. “return/refund completed”, then the prediction engine 150 is likely to predict/determine that the request for assistance is not order-related as there are no more outstanding issues with the order 134.

Therefore, in determining whether the request for assistance is order-related, the analysis of the order attributes 210 of the orders 134 can be performed on a macro-level i.e. the values of the order attributes 210 of the orders 134 are considered together, instead of comparing the values of the order attributes 210 or among the orders 134 themselves.

In some embodiments, the prediction engine 150 can analyse the order attributes 210 of the orders 134 with reference to a predetermined threshold. For example, the predetermined threshold for the order attribute 210 “planned delivery date” can be “two days out”. Therefore, if there are any order 134 with a value for order attribute 210 “planned delivery date” which is two days from the current date, then the prediction engine 150 is likely to determine that the request for assistance is order-related.

In some embodiments, each order attribute 210 can have a predetermined threshold, and the prediction engine 150 can make the determination that the request for assistance is order-related if a certain number of predetermined thresholds are exceeded.

If the method 400 predicts that the request for assistance does not relate to any of the orders 134 (i.e. that the request for assistance is not order-related), the method proceeds to step 420. In step 420, the method 400 causes the default non-order related questions to be displayed on the customer support interface 122. The default non-order related questions can be:
(1) How do I reset my account password?
(2) How do I avoid scams?
(3) What should I do if I encounter a problem/error on the platform?

Thus, the method 400 does not proceed to determine the intended order 310 when it has been predicted that the request for assistance is not order-related.

If it has been predicted that the request for assistance relates to orders 134 (i.e. that the request for assistance is order-related), the method 400 proceeds to step 406. In step 406, the method 400 determines an intended order 310 that represents the order 134 with the highest probability of having initiated the request for assistance.

In some embodiments, the determining of the intended order 310 can be done by the prediction engine 150. The determination can be based on the order attributes 210 of the orders 134. The determination can involve calculating a score for each order 134 based on the order attributes 210. The score can represent the probability of the order 134 as having initiated the request for assistance. The order 134 with the highest score can be identified to be the intended order 310 (as shown in FIG. 3).

The score of the order 134 can be calculated by assigning weights to each of the order attributes 210, as some order attributes 210 can be more important than the others. For example, the order attribute 210 “order status” may be assigned the highest weight. The score of each order 134 can be a summation of the “normalized” values of the order attributes 210 multiplied by the respective weights.

The orders 134 can be ranked based on their scores (as shown in FIG. 3). The order 134 which is the top ranked can be the intended order 310. The orders 134 which have inferior scores compared to the intended order 310 (i.e. lower ranked) can be the other orders 320. As described, the determination of the intended order 310 and the other orders 320 can be done by comparing the scores and in essence the values of the order attributes 210 between the orders 134 or among themselves (i.e. at the order level and not at the macro level).

In step 408, the method 400 causes the intended order 310 to be displayed on the customer support interface 122. The intended order 310 can be displayed in the form of an order card. The order card representing the intended order 310 can be displayed in the chatbot session.

In some embodiments, the outcomes of the chatbot session and the chat transcripts of the chatbot session may be stored as customer classification data in the historical chat information 132 of customer account 126. For example, the customer classification data can include, but is not limited to, a determination on whether the customer's 124 request for assistance was order-related, a determination on whether the chatbot session was terminated before a customer selection has been made, or a combination thereof. The acquired customer classification data can then be used to train the machine learning model/neural network model of the prediction engine 150 to make better predictions and dynamically adapt the prediction engine 150 to the customers' 124 needs which can change over time.

By selectively executing a determination of the intended order 310 only when it is has been predicted that the request for assistance is order-related, the method advantageously conserves on computational resources (e.g. CPU processing time, memory usage, etc.) and provides efficient management of computational resources, while delivering on the objectives of providing a more proactive chatbot.

Furthermore, the method 400 as described proactively and automatically predicts the intended order 310 which the customer 124 is most likely seeking assistance or needing help on, even before the customer 124 has provided any input, or asked any questions or raised any concerns. This proactive prediction of the intended order 310 will result in “immediate engagement” with the customer 124, effectively shortening the time and the number of interactions that would otherwise be required for the chatbot to troubleshoot or identify underlying orders 134. As customers 124 become more and more engaged in a chatbot session as the chatbot is providing relevant assistance, the likelihood of transferring to a customer service agent can be minimised, thereby improving and optimising operational efficiency and mitigating operational costs.

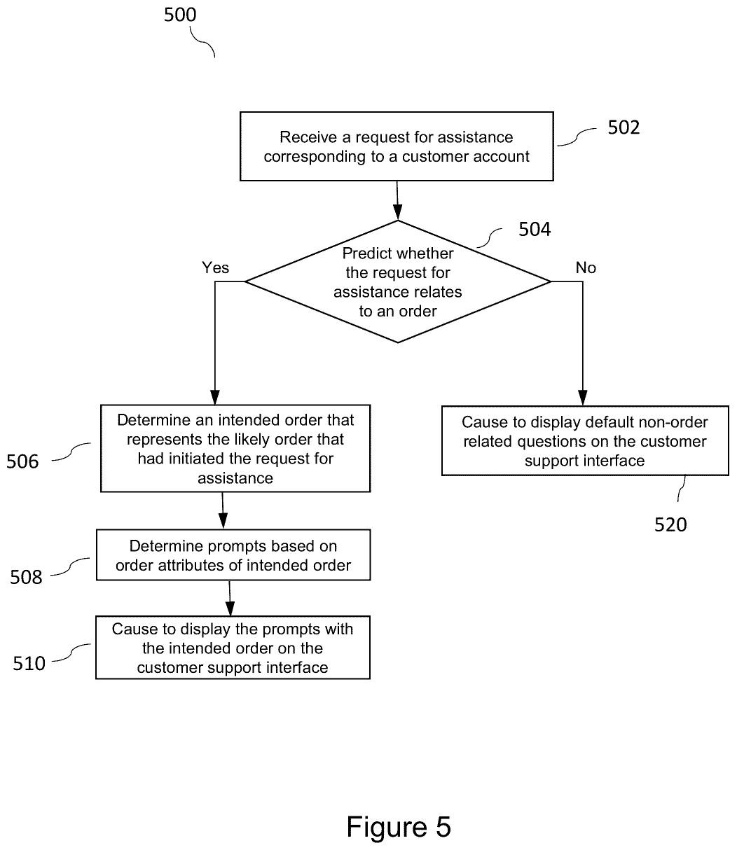

FIG. 5 shows a flowchart illustrating a method 500 for implementing a customer support interface 122 according to certain embodiments. The method 500 is explained in conjunction with the system 100 and method 400 as described earlier through the previous figures of the disclosure and same or similar processes and elements may not be described in detail.

In step 502, the method 500 receives a request for assistance corresponding to a customer account 126. Step 502 is similar to step 402 of method 400, which had been described in detail above. For the sake of brevity, step 502 of method 500 will not be described again.

In step 504, the method 500 predicts whether or not the request for assistance relates to orders 134 (i.e. whether the request for assistance is order-related), for example, the orders 134 which had been previously placed by the customer 124 on the e-commerce platform. Step 504 is similar to step 404 of method 400, which had been described in detail above. For the sake of brevity, step 504 of method 500 will not be described again.

In step 506, the method 500 determines an intended order 310 that represents the order 134 with the highest probability of having initiated the request for assistance. Step 506 is similar to step 406 of method 400, which had been described in detail above. For the sake of brevity, step 506 of method 500 will not be described again.

In step 508, the method 500 determines prompts based on order attributes 210 of the intended order 310. Prompts can refer to, for example, suggested questions or suggested content relevant to the intended order 310. In other words, prompts refer to the likely queries or requests that the customer 124 can have in relation to the intended order 310.

The determining of the prompts can be done by the prediction engine 150. The prediction engine 150 can query the prompts module 152 to retrieve a set of prompts. The prediction engine 150 can select one or more prompts from the set of prompts based on the order attributes 210 of the intended order 310. These prompts can be selected via a predefined rule. The predefined rule generally comprises one or more conditions and one or more actions to be taken if the conditions are satisfied. It should be understood that the pre-defined rule may include multiple conditions with potentially complicated inter-relationships among the conditions.

For example, if the value of the order attribute 210 “order status” of the intended order 310 is “delivery in progress”, the predefined rule can then dictate that prompts that are associated with “delivery in progress” are selected. For example, the prompts that are associated with “delivery in progress” can be:
(1) Prompt 1—When will I receive my order?
(2) Prompt 2—How can I request to track or expedite my order delivery?
(3) Prompt 3—Can I change my delivery address after my order has been placed?
   In another example, if the value of the order attribute 210 “order payment status” of the intended order 310 is “pending payment”, the predefined rule can then dictate that prompts that are associated with “pending payment” are selected. For example, the prompts that are associated with “pending payment” can be:
(4) Prompt 4—Why can't I check out with my credit card?
(5) Prompt 5—Why is the discount voucher not applied?
(6) Prompt 6—Can I get a payment confirmation email for my order?
   Thus, the predefined rules can result in the selection of prompts which are deemed to be most relevant to the intended order 310.

In an alternative implementation, the prompts may be selected based on how relevant they are to a value of the order attribute 210 of the intended order 310. For example, the prompts may be selected based on the probability of matching the prompts to a value of the order attribute 210 of the intended order 310. The prompts with higher probabilities (e.g. higher confidence scores of matching to an order attribute 210) may be selected. For example, Prompts 1, 2 or 3 may be selected based on how relevant they are when the value of the order attribute 210 “order status” of the intended order 310 is “delivery in progress”.

In step 510, the method 500 causes the prompts to be displayed with the intended order 310 on the customer support interface 122. The prompts can be displayed together and at the same time as the intended order 310. The prompts may be displayed on the customer support interface 122 without the customer 124 providing any prior input, specifically in the customer support interface 122 (e.g. without the customer 124 having to ask any questions or provide answers to questions in the chat session etc.). The prompts can be displayed in the form of a selectable element on the customer support interface 122 to be selected by the customer 124. The selectable element can be a prompts card.

Displaying the prompts (e.g. suggested questions or content) for selection by the customer 124, even before the customer 124 provides any specific input on the customer support interface 122, is advantageous as it facilitates communication about the intended order 310 while creating a personalized chat experience for the customer 124. The customer 124 can conveniently select from the prompts to advance the chatbot conversation. At the same time, the prompts enables access to one or more resolutions relevant to the intended order 310, thereby improving the resolution rate for order-related issues by the chatbot while simultaneously shortening the time that would otherwise be required for the customer 124 to resolve issues via the chatbot.

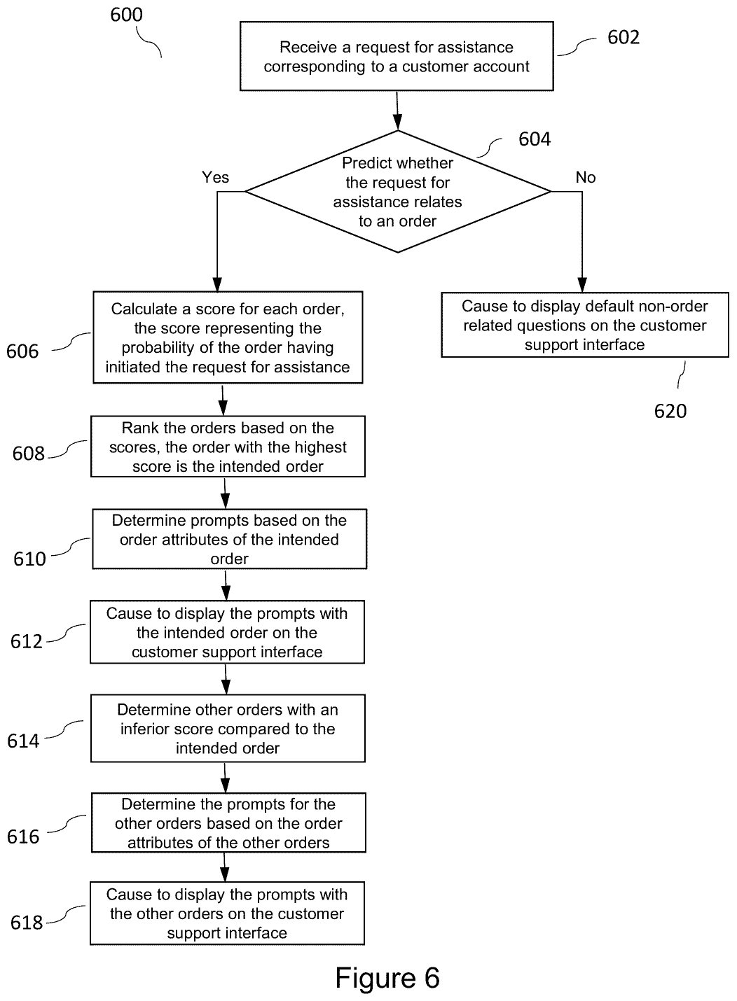

FIG. 6 shows a flowchart illustrating a method 600 for implementing a customer support interface 122 according to certain embodiments. The method 600 is explained in conjunction with the system 100 and methods 400 and 500 as described earlier through the previous figures of the disclosure and same or similar processes and elements may not be described in detail.

In step 602, the method 600 receives a request for assistance corresponding to a customer account 126. Step 602 is similar to step 402 of method 400 and step 502 of method 500, which had been described in detail above. For the sake of brevity, step 602 of method 600 will not be described again.

In step 604, the method 600 predicts whether or not the request for assistance relates to the orders 134 (i.e. whether the request for assistance is order-related). The orders 134 can be for example, orders 134 which had been previously placed by the customer 124 on the e-commerce platform. Step 604 is similar to step 404 of method 400 and step 504 of method 500, which had been described in detail above. For the sake of brevity, step 604 of method 600 will not be described again.

If the method 600 predicts that the request for assistance does not relate to any or the orders 134 (i.e. that the request for assistance is not order-related), the method 600 proceeds to step 620. Step 620 is similar to step 420 of method 400 and step 520 of method 500, which had been described in detail above. For the sake of brevity, step 620 of method 600 will not be described again.

In step 606, the method 600 calculates a score for each order 134 based on the order attributes 210 of each order 134. The score can represent the probability of the order 134 as having initiated the request for assistance. The order 134 with the highest score can be identified to be the intended order 310 (as shown in FIG. 3).

The score of the order 134 can be calculated by assigning weights to each of the order attributes 210, as some order attributes 210 can be more important than others. For example, order attribute 210 “order status” may be assigned the highest weight. The score of each order 134 can be a summation of the “normalized” values of the order attributes 210 multiplied by the respective weights.

In step 608, the method 600 ranks the orders 134 based on their scores, and identifies the order 134 with the highest score to be the intended order 310. The orders 134 can be ranked based on their scores (as shown in FIG. 3). The order 134 which is the top ranked can be the intended order 310.

In step 610, the method 600 determines the prompts based on the order attributes 210 of the intended order 310. Step 610 is similar to step 508 of method 500 which had been described in detail above. For the sake of brevity, step 610 of method 600 will not be described again.

In step 612, the method 600 causes the prompts to be displayed with the intended order 310 on the customer support interface 122. Step 612 is similar to step 510 of method 500, which had been described in detail above. For the sake of brevity, step 612 of method 600 will not be described again.

In step 614, the method 600 determines other orders 320 with an inferior score compared to the intended order 310. The orders 134 which have an inferior score compared to the intended order 310 (i.e. lower ranked) can be the other orders 320 (as shown in FIG. 3). In other words, the “other orders” represent orders 134 that have been deemed to have a lower probability/likelihood (compared to the intended order 310) of having initiated the request for assistance. As described above, the determination of the intended order 310 and the other orders 320 can be done by comparing the scores and in essence the values of the order attributes 210 and among the orders 134 themselves (i.e. at the order level and not at the macro level).

In step 616, the method 600 determines the prompts for the other orders 320 based on the order attributes 210 of the other orders 320. The determining of the prompts for the other orders 320 in step 616 can be done based on the order attributes 210 of the other orders 320, and in a similar manner to the determining of the prompts for the intended order 310, which had been described in detail above (i.e. step 508 of method 500 and step 610 of method 600). In essence, the prompts selected for each of the other orders 320, are the prompts which are deemed to be most relevant to each of the other orders 320. Therefore, as the selection of the prompts are order-specific, the prompts selected for the intended order 310 can be different from the prompts selected for the other orders 320. In the same vein, there can also be instances where the prompts selected for the intended order 310 are the same as the prompts selected for the other orders 320.

In step 618, the method 600 causes the prompts to be displayed with the other orders 320 on the customer support interface 122.

The intended order 310 can be displayed more prominently on the customer support interface 122 compared to the other orders 320. As the intended order 310 represents the order 134 with the highest probability/likelihood of having initiated the request for assistance by the customer 124, therefore making the intended order 310 easily distinguishable from the other orders 320 that have lower probability/likelihood makes the customer support interface 122 more user-friendly. Thus, convenient and proactive order support is provided as the customer 124 can conveniently select the order card representing the intended order 310 and immediately proceed with the chat query.

In some embodiments, the other orders 320 are not immediately displayed with the intended order 310 on the first interface of the customer support interface 122. Instead, the other orders 320 are only displayed in response to a customer selection of a selectable link on the first interface of the customer support interface 122. As the screens of customer devices 120 are typically limited in size, it is therefore advantageous to first display the intended order 310 on the first interface (without unnecessary elements cluttering the screen display) of the customer support interface 122, and only display the other orders 320 on a second interface of the customer support interface 122 or window upon selection of the selectable link by the customer 124. This provides a well-structured screen layout that is both practical and visually appealing to the customer 124.

In an alternative embodiment, if there is only a single or solitary order 134 in the customer account 126, the method 600 proceeds to determine the intended order 310, without calculating the score in step 606 or ranking the order 134 (in this case, the solidarity order 134) in step 608. The reasoning is that since step 604 has already determined that the request for assistance is likely to be order-related, it will be logical to conclude that the request for assistance has to be related to the solitary order 134. In this scenario, method 600 can immediately determine that the solitary order 134 has to be the intended order 310 without the need for further calculation. The method 600 can then bypass steps 606 and 608, and proceed directly to steps 610 and 612, and cause the intended order 310 to be displayed with the prompts on customer support interface 122. This advantageously conserves on computational resources, while delivering the objectives of providing proactive and convenient order support assistance.

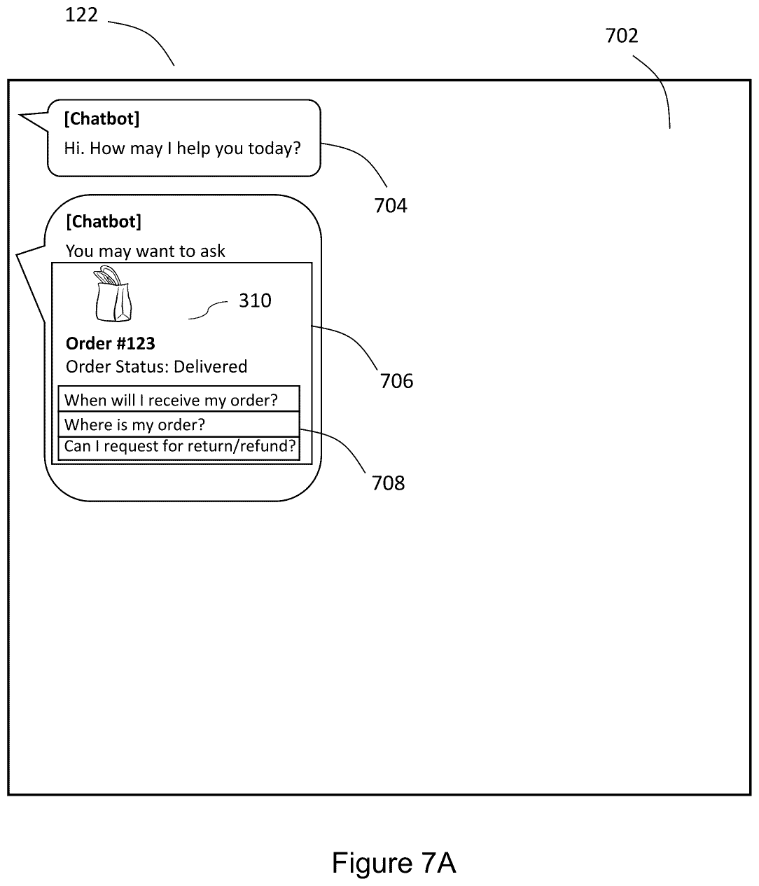

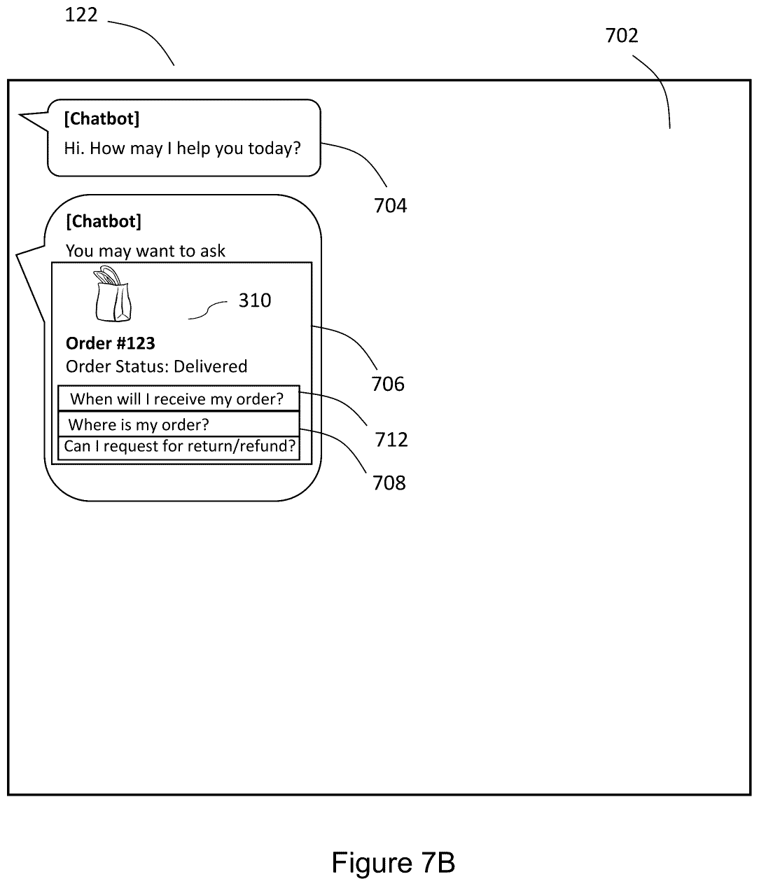

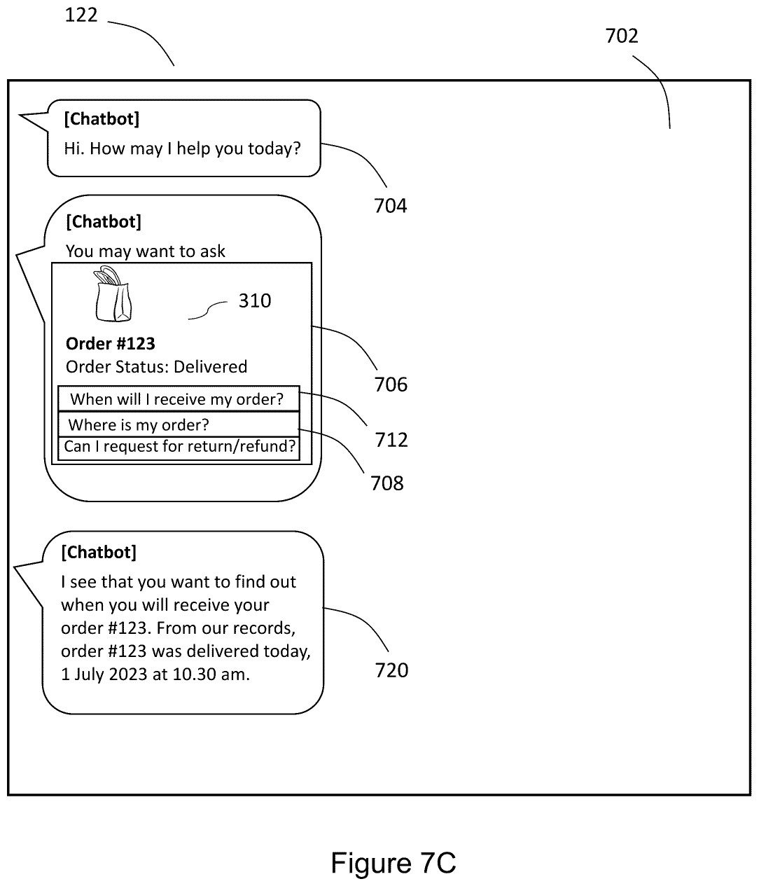

FIGS. 7A-7C show an example of a chatbot session displayed on the customer support interface 122 according to certain embodiments. The chatbot session and the customer support interface 122 are explained in conjunction with the system 100 and methods 400 and 500 as described earlier through the previous figures of the disclosure and same or similar processes and elements may not be described in detail. In particular, FIGS. 7A-7C show an exemplary illustration of a customer support interface 122 that can be presented on the display screen of a customer device 120 during some implementations of the system 100 described in FIG. 1 and the methods 400 and 500 described in FIGS. 4 and 5 respectively.

Referring to FIG. 7A, the customer support interface 122 can include chatbot session 702. Chatbot session 702 functions as a conversational dialog between a customer 124 and the chatbot of chatbot system 148 in real-time. Chatbot session 702 can display messages from the chatbot to customer 124. These messages can contain the order card 706 representing the intended order 310. The messages are, for example, presented in a text bubble. Other types of message containers can also be used to present the messages. Chatbot session 702 can also have an active text-based communication area for customers 124 to provide input (not shown). This input can also be presented in the form of messages.

FIG. 7A shows the customer support interface 122 as displayed on the customer device 120. The customer 124 has logged into the customer account 126 or otherwise provided credentials to authenticate or verify his/her identity. The customer 124 has requested for assistance. In response to the request for assistance, the prediction engine 150 has performed the methods as described above, and has caused order card 706 representing the intended order 310 (order #123) to be displayed in the chatbot session 702. The order card 706 can be displayed with a welcome message 704 to indicate the start of the chatbot session 702.

The order card 706 can indicate the order status as “delivered”, and also provide a picture of the ordered items (in this case, it is a handbag). The customer 124 can submit a query about the intended order 310 by entering audio or text input into the chatbot session 702.

Still referring to FIG. 7A, the prediction engine 150 has performed the methods as described above, and the chatbot displays the prompts with the intended order 310. The prompts can be displayed in the form of prompts card 708. The prompts cards 708 may be selectable by the customer 124. The prompts card 708 may be representative of any number of prompts that may be deemed relevant to the intended order 310 and can be displayed at any designated position in chatbot session 702.

The customer 124 may select any one of the prompts in the prompts card 708, or submit a query to the chatbot about the intended order 310. As shown in FIG. 7B, the chatbot session 702 indicates receipt of a customer selection 712 of the prompt “When will I receive my order”.

Customer's 124 input about the intended order 310 (such as customer selection 712) can be used as positive feedback information to train and update one or more portions of the machine learning/neural network model of the prediction engine 150. Positive feedback, in this case, can refer to any customer's input which affirms that the request for assistance was order-related. For example, the customer's 124 input can take the form of a query entered by the customer 124 in the chatbot session 702 about the intended order 310, a customer selection of a selectable element representing the intended order 310 (i.e. the order card 706), or a customer selection of a selectable element representing the prompts (i.e. the customer selection 712).

Conversely, the customer's 124 input about the intended order 310 can be used as negative feedback information to train and update one or more portions of the machine learning/neural network model of the prediction engine 150. Negative feedback, in this case, can refer to any customer's 124 input which affirms that the request for assistance was not order-related. For example, the customer's 124 input can take the form of a query entered by the customer 124 in the chatbot session 702 relating to an order 134 that is not the intended order 310, a customer selection of a selectable element representing an order 134 that is not the intended order 310, a customer selection of a prompt that is not related to the intended order 310, or the customer 124 terminating the chatbot session 702.

In some embodiments, the customer selection 712 of the prompts can be used as positive feedback information to train and update one or more portions of the machine learning/neural network model of the prediction engine 150. Positive feedback, in this case, can refer to any customer's 124 input that indicates relevance of the prompts. For example, the customer's 124 input can take the form of a query entered by the customer 124 in the chatbot session 704 that is related to the prompts, and a customer selection of a selectable element that represents the prompts (i.e. customer selection 712).

Conversely, the non-selection of customer selection 712 of the prompts can be used as negative feedback information to train and update one or more portions of the machine learning/neural network model of the prediction engine 150. Negative feedback, in this case, can refer to any input from the customer 124 that indicates non-relevance of the prompts. For example, the customer's 124 input can take the form of a query entered in the chatbot session 702 that is not related to any of the prompts, a customer selection of a selectable element that is not any of the prompts, or the customer 124 terminating the chatbot session 702.

Now referring to FIG. 7C, the chatbot has processed the customer selection 712 and generated a reply 720 that answers the query from the customer 124.

Therefore as shown, the chatbot session 702 of the customer support interface 122 advantageously displays the order card 706 representing the intended order 310 and the prompts card 708 without any prior input from the customer 124. By automatically suggesting one or more prompts based on an intended order 310, the customer 124 can conveniently select from the prompts to advance the chatbot conversation.

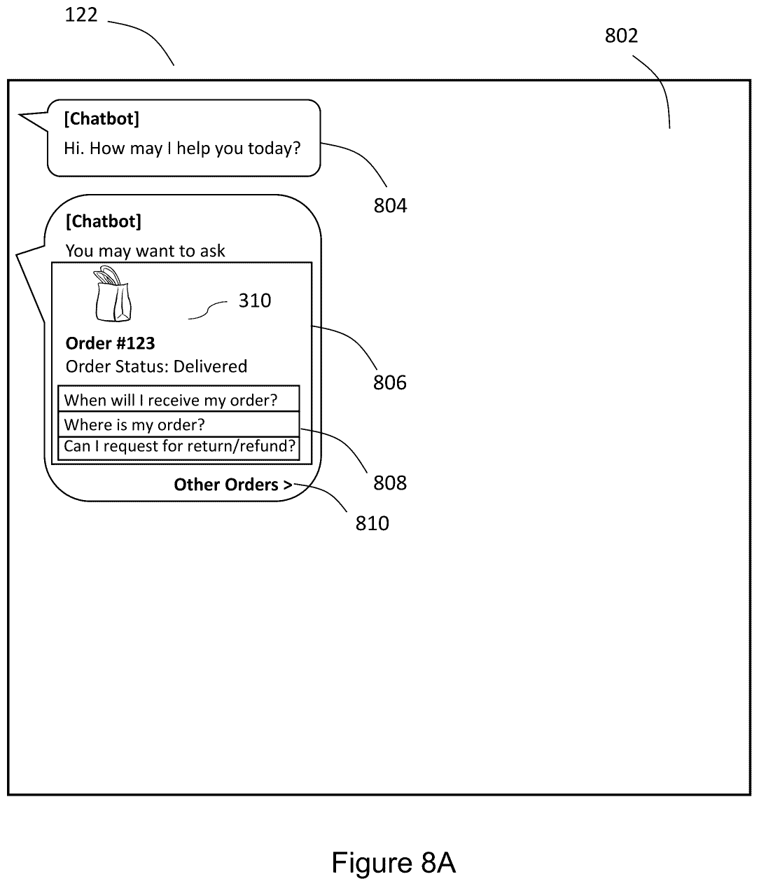

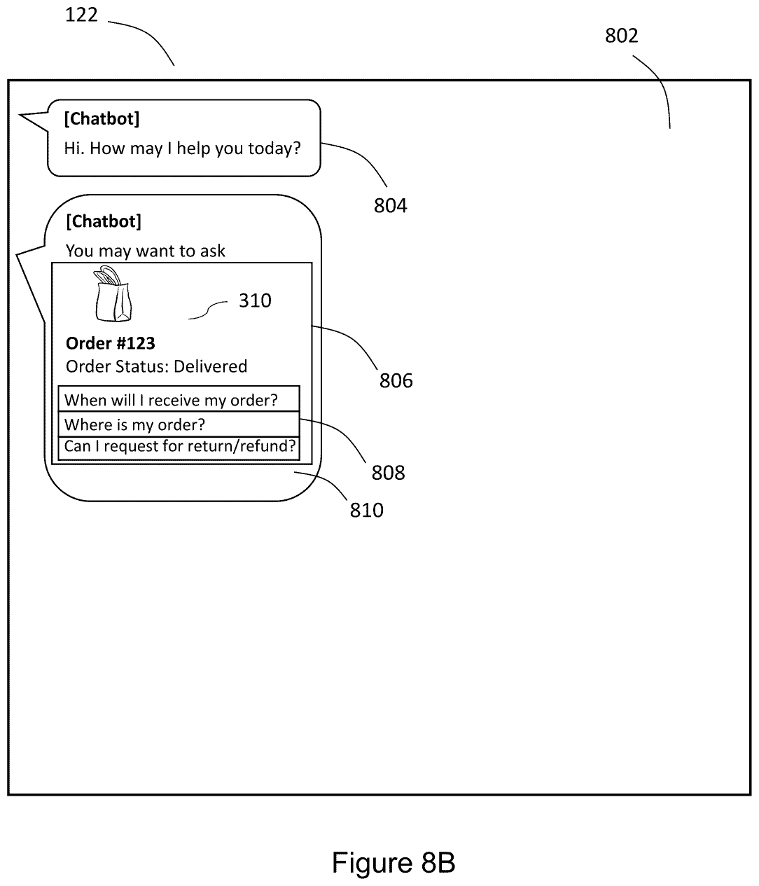

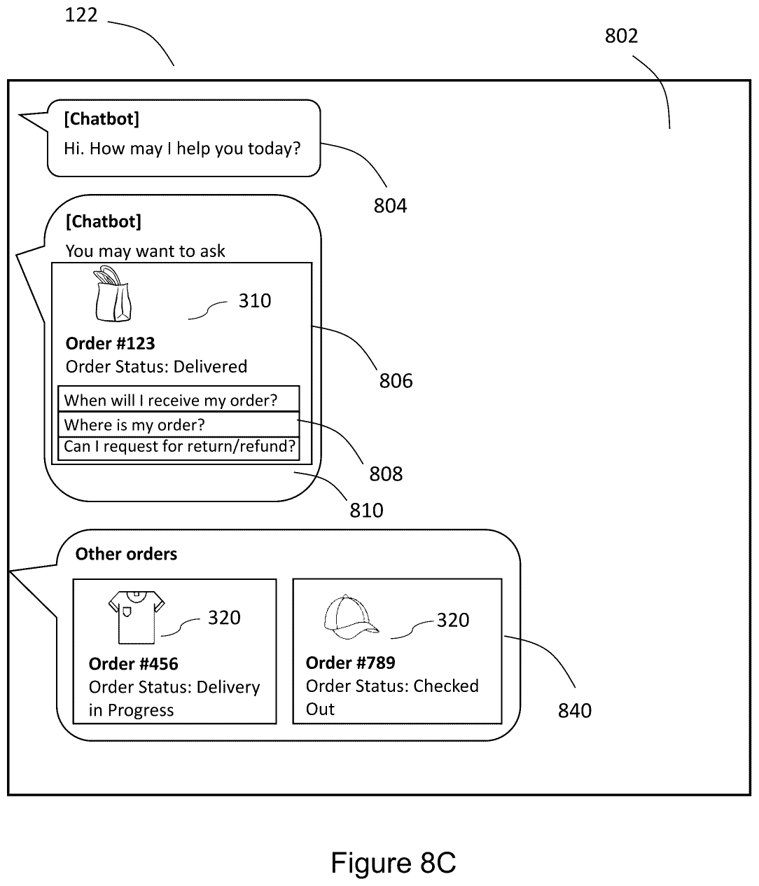

In an exemplary implementation of the system 100 and the method 600 described in FIG. 6, FIG. 8A shows the chatbot session 802 of the customer support interface 122 as displayed on the customer device 120. The customer 124 has logged into the customer account 126 or otherwise provided credentials to authenticate or verify his/her identity. The customer 124 has requested for assistance. In response to the request for assistance, the prediction engine 150 has performed the methods as described above, and has caused the order card 806 representing the intended order 310, the prompts card 808 representing the prompts to be displayed in chatbot session 802. The order card 806 and the prompts card 808 can be displayed with a welcome message 804 in the chatbot session 802 to indicate the start of the chatbot session 802. The order card 806 can indicate the order status as “delivered”, and also provide a picture of the ordered items (in this case, it is a handbag). The customer 124 can submit a query to the chatbot about the intended order 310 by entering audio or text input into the chatbot session 802.

The prediction engine 150 has performed the methods as described above to determine the other orders 320. As shown in FIG. 8B, the other orders 320 is initially hidden from view. FIG. 8B illustrates that the other orders 320 may be accessible via the selection of the selectable link 810 by the customer 124. The selectable link 810 can be for example, a hyperlink. The selectable link 810 can be selected by the customer 124 to open or launch a second interface should the customer 124 be interested in viewing the details of the other orders 320. Alternatively, the selectable link 810 can expand or collapse the details of the other orders 320 upon its selection.

In some embodiments, the selection of the selectable link 810 by the customer 124 can be used as positive feedback information to train and update one or more portions of the machine learning model of the prediction engine 150. Positive feedback, in this case, refers to any customer's 124 input which indicates that the request for assistance was related to the other orders 320. For example, the customer's 124 input can take the form of a query entered by the customer 124 in the chatbot session 802 about the other orders 320, a customer selection of a selectable element representing the other orders 320, or a customer selection of a selectable element representing the one or more prompts displayed with the other orders 320.

Conversely, the non-selection of the selectable link 810 by the customer 124 can be used as negative feedback information to train and update one or more portions of the machine learning model of the prediction engine 150. Negative feedback, in this case, refers to any customer's 124 input which indicates that the request for assistance was not related to the other orders 320. For example, the customer's 124 input can take the form of a query entered by the customer 124 in the chatbot session 802 relating to an order 134 which is not the other order 320, a query entered by the customer in the chatbot session that is not related to the other order 320, a customer selection of a selectable element that is not related to the other order 320 (e.g. selection of a live agent button), or the customer 124 terminating the chatbot session 802.

In an alternative embodiment, the selection of the selectable link 810 can trigger a further determination of the other orders 320. The further determination can be performed by the prediction engine 150.

Referring to FIG. 8C, the customer 124 has selected the selectable link 810, and the order card 840 representing the other orders 320 (order #456 and order #789) are displayed in the chatbot session 802. The order card 840 can indicate the order status of the other orders 320, and also provide a picture of the ordered items (in this case, it is a T shirt and a cap). The customer 124 can submit a query to the chatbot about the other orders 320 by entering audio or text input into the chatbot session 802. As shown in FIGS. 8A-8C, by displaying the other orders 320 only upon selection by the customer 124 advantageously provides a well-structured screen layout (without unnecessary elements cluttering the screen display) that is both practical and visually appealing to the customer 124.

The other orders 320 can also be displayed with prompts in the chatbot session 802 (not shown) in a similar fashion to what has been described for the intended order 310. It should also be appreciated that the order cards 840 may be differently positioned and that the ranking may be differently indicated. For example, the order cards 840 can show ten other orders 320 and these other orders 320 may be displayed according to any suitable factors such as ranking based on their scores (as shown in FIG. 3), or a timestamp of the customer activity information 130 (e.g. recent payment information), or a timestamp of an order attribute 210 (e.g. recent update of order status). The chatbot session 802 is intended to be illustrative only, and any number of order cards 840 may be displayed or presented.

Aspects of the disclosed invention can include one or more of the following, including variations thereof:
Aspect 1. A method of implementing a customer support interface for order support assistance, the method comprising steps for: receiving a request for assistance corresponding to a customer account of a customer, the customer account being associated with at least one order, wherein the customer account comprises customer account information, and wherein the at least one order comprises order attributes; predicting with a prediction engine implementing a machine learning model, whether the request for assistance relates to the at least one order, wherein the predicting is based on one of, or both of, the customer account information and the order attributes of the at least one order; in response to predicting that the request for assistance relates to the at least one order, determining with the prediction engine, an intended order from the at least one order, wherein the intended order represents the at least one order with a highest probability of having initiated the request for assistance; and causing the intended order to be displayed on the customer support interface on a customer device.
Aspect 2. The method of Aspect 1, wherein the step of determining the intended order from the at least one order comprises the steps of: calculating a score for each of the at least one order based on the order attributes of the at least one order, the score of the at least one order representing the probability of the at least one order having initiated the request for assistance; and identifying the at least one order with a highest score to be the intended order.
Aspect 3. The method of any of Aspects 1 to 2, further comprising the steps of: retrieving order attributes of the intended order; determining by the prediction engine, one or more prompts based on the order attributes of the intended order; and causing the one or more prompts to be displayed with the intended order on the customer support interface.
Aspect 4. The method of any of Aspects 1 to 3, wherein the step of determining the one or more prompts comprises the steps of: retrieving a set of prompts from a database; and selecting one or more prompts from the set of prompts according to a predefined rule.
Aspect 5. The method of any of Aspects 1 to 4, wherein the one or more prompts is to be displayed with the intended order in a chatbot session on the customer support interface.
Aspect 6. The method of any of Aspects 1 to 5, further comprising the steps of: ranking the at least one order based on the score of the at least one order; and determining with the prediction engine, at least one other order from the at least one order, wherein the at least one other order has an inferior score compared to the intended order.
Aspect 7. The method of any of Aspects 1 to 6, further comprising the step of causing the intended order to be displayed more prominently on the customer support interface compared with the at least one other order.
Aspect 8. The method of any of Aspects 1 to 7, wherein the step of causing the intended order to be displayed more prominently on the customer support interface compared with the at least one other order comprises the steps of: causing the intended order to be displayed on a first interface of the customer support interface; and causing a selectable link to be presented on the first interface; wherein the at least one other order is displayed on a second interface of the customer support interface in response to a customer selection of the selectable link.
Aspect 9. The method of any of Aspects 1 to 8, wherein the at least one other order is displayed on the second interface based on the ranking of the at least one order.
Aspect 10. The method of any of Aspects 1 to 9, further comprising the steps of: receiving an input from the customer which affirms that the request for assistance was related to the intended order; and updating the machine learning model of the prediction engine.
Aspect 11. The method of any of Aspects 1 to 10, wherein the input from the customer which affirms that the request for assistance was related to the intended order, comprises any one of: a query entered by the customer in the chatbot session about the intended order, a customer selection of a selectable element representing the intended order, or a customer selection of a selectable element representing the one or more prompts.
Aspect 12. The method of any of Aspects 1 to 11, further comprising the steps of: receiving an input from the customer which affirms that the request for assistance was not related to the intended order; and updating the machine learning model of the prediction engine.
Aspect 13. The method of any of Aspects 1 to 12, wherein the input from the customer which affirms that the request for assistance was not related to the intended order, comprises any one of: a query entered by the customer in the chatbot session relating to an order which is not the intended order, a query entered by the customer in the chatbot session that is not related to the intended order, a customer selection of a selectable element that is not related to the intended order, or the customer terminating the chatbot session.
Aspect 14. The method of any of Aspects 1 to 13, further comprising the steps of: receiving an input from the customer that indicates relevance of the one or more prompts; and updating the machine learning model of the prediction engine.
Aspect 15. The method of any of Aspects 1 to 14, wherein the input from the customer that indicates relevance of the one or more prompts, comprises a query entered by the customer in the chatbot session that is related to the one or more prompts, or a customer selection of a selectable element that represents the one or more prompts.
Aspect 16. The method of any of Aspects 1 to 15, further comprising the steps of: receiving an input from the customer that indicates non-relevance of the one or more prompts; and updating the machine learning model of the prediction engine.
Aspect 17. The method of any of Aspects 1 to 16, wherein the input from the customer that indicates non-relevance of the one or more prompts, comprises any one of: a query entered in the chatbot session that is not related to any of the one or more prompts, a customer selection of a selectable element that is not any of the one or more prompts, and the customer terminating the chatbot session.
Aspect 18. The method of any of Aspects 1 to 17, wherein the customer account information comprises customer profile information, customer activity information, historical chat information, or a combination thereof.
Aspect 19. The method of any of Aspects 1 to 18, wherein the order attributes comprises order status, order date, planned delivery date, actual order delivery date, delivery method, order value, order history, payment method, order payment status, merchant identifier, item identifier, or a combination thereof.
Aspect 20. The method of any of Aspects 1 to 19, wherein the request for assistance is initiated via activation of a help button on a home page of an e-commerce platform; and wherein the home page of the e-commerce platform provides no information on the at least one order.
Aspect 21. A system comprising one or more computers and one or more storage devices storing computer-readable instructions that, when executed by the one or more computers, cause the one or more computers to perform one or more operations comprising: receiving a request for assistance corresponding to a customer account of a customer, the customer account being associated with at least one order, wherein the customer account comprises customer account information, and wherein the at least one order comprises order attributes; predicting with a prediction engine implementing a machine learning model, whether the request for assistance relates to the at least one order, wherein the predicting is based on one of, or both of, the customer account information and the order attributes of the at least one order; in response to predicting that the request for assistance relates to the at least one order, determining with the prediction engine, an intended order from the at least one order, wherein the intended order represents the at least one order with a highest probability of having initiated the request for assistance; and causing the intended order to be displayed on a customer support interface on a customer device.
Aspect 22. One or more non-transitory computer storage media storing instructions that, when executed by one or more computers, cause the one or more computers to perform one or more operations for: receiving a request for assistance corresponding to a customer account of a customer, the customer account being associated with at least one order, wherein the customer account comprises customer account information, and wherein the at least one order comprises order attributes; predicting with a prediction engine implementing a machine learning model, whether the request for assistance relates to the at least one order, wherein the predicting is based on one of, or both of, the customer account information and the order attributes of the at least one order; in response to predicting that the request for assistance relates to the at least one order, determining with the prediction engine, an intended order from the at least one order, wherein the intended order represents the at least one order with a highest probability of having initiated the request for assistance; and causing the intended order to be displayed on a customer support interface on a customer device.

The present methodologies described herein are fully intended to be operable on a variety of devices or systems. Any hardware platform suitable for performing the methodologies described here is suitable for use with the invention. Unless specifically stated otherwise, and as apparent from the following, it will be appreciated that throughout the present specification, discussions utilizing terms such as “receiving”, “identifying”, ‘initiating”, “tagging”, “transmitting”, “running”, “incrementing”, “determining”, “assigning”, “approving”, “selecting”, “sending”, “calculating”, “analysing”, “replacing”, “generating”, “initializing”, “outputting”, “training” or the like, refer to the action and processes of a computer system, or similar electronic device, that manipulates and transforms data represented as physical quantities within the computer system into other data similarly represented as physical quantities within the computer system or other information storage, transmission or display devices.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

What is claimed is:

1. A method of implementing a customer support interface for order support assistance, the method comprising steps for:
receiving a request for assistance corresponding to a customer account of a customer, the customer account being associated with at least one order, wherein the customer account comprises customer account information, and wherein the at least one order comprises order attributes;
predicting with a prediction engine implementing a machine learning model, whether the request for assistance relates to the at least one order, wherein the predicting is based on one of, or both of, the customer account information and the order attributes of the at least one order;
in response to predicting that the request for assistance relates to the at least one order, determining with the prediction engine, an intended order from the at least one order, wherein the intended order represents the at least one order with a highest probability of having initiated the request for assistance; and
causing the intended order to be displayed on the customer support interface on a customer device.

2. The method of claim 1, wherein the step of determining the intended order from the at least one order comprises the steps of:
calculating a score for each of the at least one order based on the order attributes of the at least one order, the score of the at least one order representing the probability of the at least one order having initiated the request for assistance; and
identifying the at least one order with a highest score to be the intended order.

3. The method of claim 1, further comprising the steps of:
retrieving order attributes of the intended order;
determining by the prediction engine, one or more prompts based on the order attributes of the intended order; and
causing the one or more prompts to be displayed with the intended order on the customer support interface.

4. The method of claim 3, wherein the step of determining the one or more prompts comprises the steps of:
retrieving a set of prompts from a database; and
selecting one or more prompts from the set of prompts according to a predefined rule.

5. The method of claim 3, wherein the one or more prompts is to be displayed with the intended order in a chatbot session on the customer support interface.

6. The method of claim 2, further comprising the steps of:
ranking the at least one order based on the score of the at least one order; and
determining with the prediction engine, at least one other order from the at least one order, wherein the at least one other order has an inferior score compared to the intended order.

7. The method of claim 6, further comprising the step of causing the intended order to be displayed more prominently on the customer support interface compared with the at least one other order.

8. The method of claim 7, wherein the step of causing the intended order to be displayed more prominently on the customer support interface compared with the at least one other order comprises the steps of:
causing the intended order to be displayed on a first interface of the customer support interface; and
causing a selectable link to be presented on the first interface;
wherein the at least one other order is displayed on a second interface of the customer support interface in response to a customer selection of the selectable link.

9. The method of claim 8, wherein the at least one other order is displayed on the second interface based on the ranking of the at least one order.

10. The method of claim 5, further comprising the steps of:
receiving an input from the customer which affirms that the request for assistance was related to the intended order; and
updating the machine learning model of the prediction engine.

11. The method of claim 10, wherein the input from the customer which affirms that the request for assistance was related to the intended order, comprises any one of: a query entered by the customer in the chatbot session about the intended order, a customer selection of a selectable element representing the intended order, or a customer selection of a selectable element representing the one or more prompts.

12. The method of claim 5, further comprising the steps of:
receiving an input from the customer which affirms that the request for assistance was not related to the intended order; and
updating the machine learning model of the prediction engine.

13. The method of claim 12, wherein the input from the customer which affirms that the request for assistance was not related to the intended order, comprises any one of: a query entered by the customer in the chatbot session relating to an order which is not the intended order, a query entered by the customer in the chatbot session that is not related to the intended order, a customer selection of a selectable element that is not related to the intended order, or the customer terminating the chatbot session.

14. The method of claim 5, further comprising the steps of:
receiving an input from the customer that indicates relevance of the one or more prompts; and
updating the machine learning model of the prediction engine.

15. The method of claim 14, wherein the input from the customer that indicates relevance of the one or more prompts, comprises a query entered by the customer in the chatbot session that is related to the one or more prompts, or a customer selection of a selectable element that represents the one or more prompts.

16. The method of claim 5, further comprising the steps of:
receiving an input from the customer that indicates non-relevance of the one or more prompts; and
updating the machine learning model of the prediction engine.

17. The method of claim 16, wherein the input from the customer that indicates non-relevance of the one or more prompts, comprises any one of: a query entered in the chatbot session that is not related to any of the one or more prompts, a customer selection of a selectable element that is not any of the one or more prompts, and the customer terminating the chatbot session.

18. The method of claim 1, wherein the customer account information comprises customer profile information, customer activity information, historical chat information, or a combination thereof.

19. A system comprising one or more computers and one or more storage devices storing computer-readable instructions that, when executed by the one or more computers, cause the one or more computers to perform one or more operations comprising:
receiving a request for assistance corresponding to a customer account of a customer, the customer account being associated with at least one order, wherein the customer account comprises customer account information, and wherein the at least one order comprises order attributes;
predicting with a prediction engine implementing a machine learning model, whether the request for assistance relates to the at least one order, wherein the predicting is based on one of, or both of, the customer account information and the order attributes of the at least one order;
in response to predicting that the request for assistance relates to the at least one order, determining with the prediction engine, an intended order from the at least one order, wherein the intended order represents the at least one order with a highest probability of having initiated the request for assistance; and
causing the intended order to be displayed on a customer support interface on a customer device.

20. One or more non-transitory computer storage media storing instructions that, when executed by one or more computers, cause the one or more computers to perform one or more operations for:
receiving a request for assistance corresponding to a customer account of a customer, the customer account being associated with at least one order, wherein the customer account comprises customer account information, and wherein the at least one order comprises order attributes;
predicting with a prediction engine implementing a machine learning model, whether the request for assistance relates to the at least one order, wherein the predicting is based on one of, or both of, the customer account information and the order attributes of the at least one order;
in response to predicting that the request for assistance relates to the at least one order, determining with the prediction engine, an intended order from the at least one order, wherein the intended order represents the at least one order with a highest probability of having initiated the request for assistance; and
causing the intended order to be displayed on a customer support interface on a customer device.
